(19) United States
(12) Patent Application Publication
(10) Pub. No.: US 2014/0136433 A1
(43) Pub. Date: May 15, 2014

(54) REFERRING MEMBERS OF A SOCIAL NETWORK AS JOB CANDIDATES

(71) Applicants: Christian Posse, Forster City, CA (US); Andrew P. Hill, San Francisco, CA (US); Anmol Bhasin, Mountain View, CA (US); Cindy Yao Chen, Sunnyvale, CA (US); Sachit Kamat, San Mateo, CA (US)

(72) Inventors: Christian Posse, Forster City, CA (US); Andrew P. Hill, San Francisco, CA (US); Anmol Bhasin, Mountain View, CA (US); Cindy Yao Chen, Sunnyvale, CA (US); Sachit Kamat, San Mateo, CA (US)

(21) Appl. No.: 13/678,236

(22) Filed: Nov. 15, 2012

(51) Int. Cl. G06Q 99/00

(52) U.S. Cl. 705/319

(57) ABSTRACT

Systems and methods for referring members of a social network as job candidates are described. In some examples, the systems and methods receive information associated with a job or a company associated with a job, identify members of a social network based on attributes for the members, and perform an action (e.g., send an email or update a widget on a profile page) associated with a member of the social network that is connected to the identified members and affiliated with the company.

### TECHNICAL FIELD

The present disclosure generally relates to data processing techniques associated with job referrals. More specifically, the present disclosure relates to methods, systems and computer program products for referring members of a social network as job candidates.

### BACKGROUND

In an effort to find the best people to fill vacant positions, companies look for candidates through a variety of venues. They post job advertisements, attend or put on job fairs, recruit on university campuses, ask employees for referrals, and so on. They go to these lengths because it can be very difficult to identify candidates for vacant positions, especially talented or desired candidates. Similarly, job seekers often find it difficult to find attractive positions, even when there are many vacancies in the field.

### DESCRIPTION OF THE DRAWINGS

Some embodiments of the technology are illustrated by way of example and not limitation in the figures of the accompanying drawings, in which:

FIG. 1 is a block diagram illustrating an example of a network environment including a server operating a system for referring members of a social network as job candidates, consistent with some embodiments.

FIG. 2 is a block diagram illustrating modules of a referral system, consistent with some embodiments.

FIG. 3 is a flow diagram illustrating an example method for referring members of a social network as job candidates, consistent with some embodiments.

FIGS. 4A-4B are display diagrams illustrating actions performed to refer members of a social network as job candidates, consistent with some embodiments.

FIG. 5 is a flow diagram illustrating an example method for presenting referral candidate information, consistent with some embodiments.

FIGS. 6A-6B are display diagrams illustrating the presentation of referral candidate information via a user interface, consistent with some embodiments.

FIG. 7 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for referring members of a social network as job candidates. In some examples, the systems and methods receive information associated with a job or a company associated with a job, identify members of a social network based on attributes for the members (e.g., attributes identified from a member's profile), and perform an action (e.g., send an email or update a widget on a profile page) associated with a member of the social network that is connected to the identified members and affiliated with the company.

For example, a referral system within a professional social network receives information about a job at Company X. The information includes a description of the job, such as the job title, the required years of experience, and so on. The referral system identifies, via member profile information, members of the social network that have attributes (e.g., previous or current job titles, years experience in similar jobs) that match or are similar to the job description. In other words, the referral system identifies members of the social network that would be suitable candidates for the job, based on their attributes.

The referral system may send an email to another member that is associated with Company X (e.g., is currently employed by Company X) and connected to the identified member. The email may include information about the identified members, as well as user-selectable buttons that, when selected, cause the social network to communicate the member information to various entities associated with the job, such as a member acting as a recruiter within the social network. That is, the member associated with Company X selects the button to refer the identified member to the company as a candidate, or to refer the company and/or job posting to the member, among other things.

Thus, in some examples, the social network utilizes data stored in the network, such as data associated with its members (e.g., member attribute data), social graph data (e.g., data indicating relationships between members within a social network) and/or data associated with available jobs at companies, to refer members of the social network to companies seeking job candidates, among other things. Such referrals may facilitate connections between companies looking for new employees and members of the social network looking, actively or passively, for new opportunities, among other benefits.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

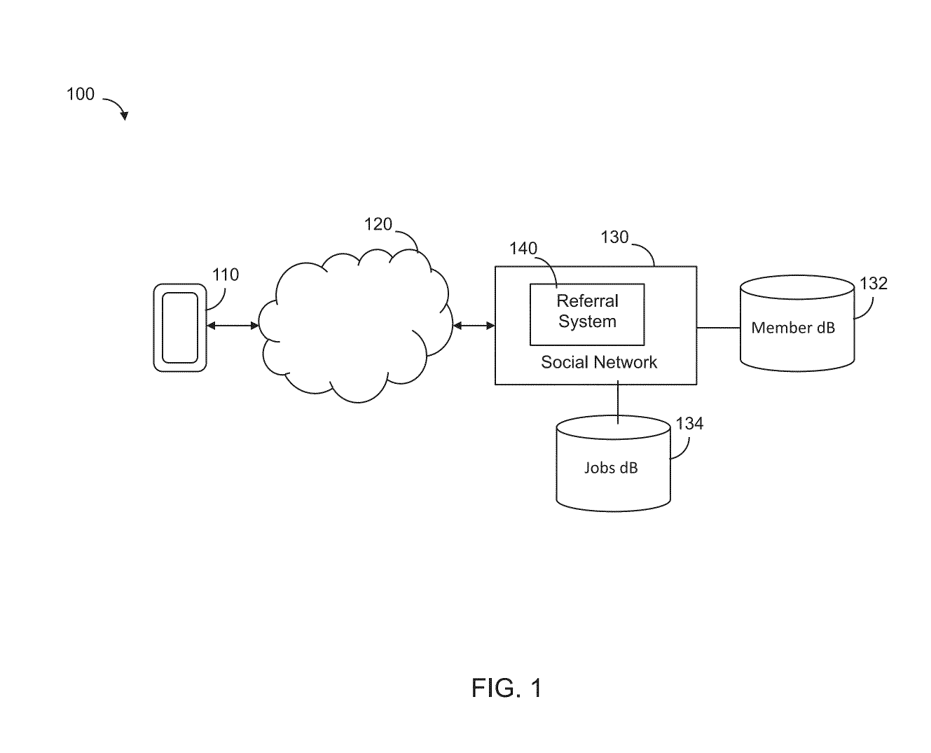

FIG. 1 is a block diagram illustrating an example of a network environment 100 including a server operating a system for referring members of a social network as job candidates consistent with some embodiments. The network environment 100 includes a user device 110, such as a mobile device or computing device, that accesses a social network service 130 over a network 120. The social network service 130 may be a professional social network or any social network that includes members, where a member is connected to, friends with, or otherwise affiliated with some of the other members of the network. Thus, in some examples, the social network service 130 includes a social graph that stores data identifying relationships between members of the social network. For example, social graph data may indicate one member is a 1^{st} degree connection with another member when the members are directly connected, may indicate one member is a 2^{nd} degree connection with another member when the members are indirectly connected via a third member (i.e., each of the members are directly connected to a third member but not directly connected to each other), and so on.

In some examples, the social network service 130 may include a referral system 140 that includes systems and performs methods for referring members of the network as job candidates.

Additionally, the social network service 130 may contain, store, and/or have access to (e.g., via a third party site) various types of information, such as information 132 associated with the members of the network (e.g., member profile information), information associated 134 with companies that have a presence within the social network (e.g., post listings for available jobs), and so on.

In various example embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks. The user device 110 may be any suitable computing device, such as a smart phone, a tablet, a laptop, gaming device, and/or any mobile device or computing device configured to display job listings and receive selections from users of objects displayed by webpages, emails, and/or apps.

A social network is a useful place in which to obtain various types of information associated with members that are actively or passively looking for a job. Often, a social network or other similar site, such as LinkedIn, Facebook, Google+, Twitter, and so on, stores various types of information or attributes associated with members of the site as member profile information. For example, a friend-based social networking service may store interest information for a member (e.g., information about things a member “likes”) in the member's profile, whereas a business-based social networking site may store accomplishment or experience information for a member (e.g., educational or work experience information) in the member's profile. Additionally, the social networking service 130 may store a variety of information associated with a member's social graph, such as information identifying other members within the member's social graph.

For example, for a given member associated with the user device 110, the referral system 140 may match data from the member database 132 to data from the jobs database 134 in order to identify members connected to the member associated with the user device 110 to be referred to available jobs posted by a company that employs the member associated with the user device 110. The referral system may then display and/or provide such information to the member via the user device 110, and facilitate the member initiating referrals of the identified members as candidates for the available jobs.

### Job Referrals Using Social Network Information

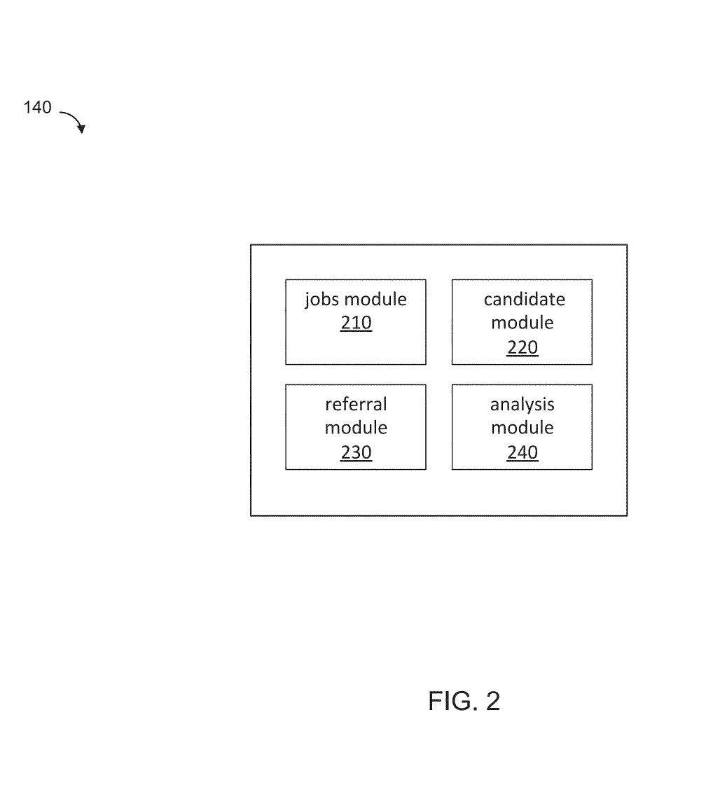

As described herein, in some example embodiments, the referral system 140 utilizes various types of data or other information stored by a social network in order to identify members of the social network to refer to a company as job candidates. FIG. 2 is a block diagram illustrating modules of a referral system 140, consistent with some embodiments.

As illustrated in FIG. 2, the referral system 140 includes a variety of functional modules. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

Referring to FIG. 2, the referral system 150 includes a jobs module 210, a candidate module 220, a referral module 230, and an analysis module 240.

In some examples, the jobs module 210 is configured and/or programmed to receive and/or obtain information associated with a company or companies, such as information identifying available jobs at the company. For example, the jobs module 210 may obtain information from a job listing posted within the social network 130. The information from the job listing may include job description information, such as information associated with a job title, required experience, required skills, required education, and so on. In other examples, the jobs module 210 may obtain information associated with jobs from thirds party sites outside or associated with the social network, such as job listing services, employment sites, and so on.

In some examples, the candidate module 220 is configured and/or programmed to identify, determine, and/or select one or more members of the social network as candidates for the available job. The candidate module 220 may identify a member of the social network as a candidate by matching information associated with the member, such as attributes assigned to the member, to information associated with a company or available job, such as information received by the jobs module 210.

Example data and/or information that may be used to determine whether a member of a social network matches information associated with a job or company includes:

Profile information, such as information associated with a member's educational background (e.g., school information, degree information, grade information, exam information, activity information, organization information, and so on), work history (e.g., company information, job title information, job skills information, job responsibility information, length of employment information, and so on), member information (e.g., residence information, citizenship information, language information, activity and interest information, and so on), and so on; and/or

Social graph information, such as profile information associated with friends, connections, group affiliations, references, and so on, of a member;

Member activity information, such as historical information associated with activities performed by members of a social network within the social network. Example activities may include viewing content, selecting job listings, following company profiles, viewing group messages, viewing certain types of members, and so on; and so on.

In some examples, the candidate module 220 may determine and assign a match score to a member that indicates whether the member is a satisfactory candidate of an available job, based on a variety of factors. For example, the candidate module 220 may determine a match score, or other metric, based on: (1) a level of matching of the member attributes to the information associated with the job; (2) whether the member is an active candidate (unemployed and/or has indicated a desire to receive employment offers) or a passive candidate (employed and/or does not want to accept employment offers); (3) the relationships between the member and other members of the social network that are associated with the company advertising the job; and so on.

For example, the candidate module 220 may assign a high score to a member (indicating the member is a good referral candidate) when the member's job history includes a title similar to the title of the job description but the member is not open to employment offers, or when the member's job history does not exactly match the job description, but the member is not currently employed, among other cases.

On the other hand, the candidate module 220 may assign a low score to a member (indicating the member is not a good referral candidate) when the member's job history includes a number of titles similar to the title of the job description but the member is not connected to any other members employed by the company advertising the job, or when the member is currently employed by a direct competitor of the company advertising the job, among other cases. One of ordinary skill in the art will appreciate that the candidate module 220 may assign scores to members for a variety of factors, depending on the needs of the system.

In some examples, the referral module 230 is configured and/or programmed to perform an action associated with referring an identified member as a candidate for the available job. For example, the referral module 230 may generate and transmit an email to a distinguished member of the social network that is affiliated with the company advertising the job and connected to the members of the social network identified as candidates for the job. The email, or other message, may present information associated with identified members, along with user-selectable objects configured to cause the social network to refer the one or more members to the company when selected by the distinguished member.

As another example, the referral module 230 may generate and display a widget via the distinguished member's home page of the social network that presents information about the identified members along with user-selectable objects configured to cause the social network to refer the one or more members to the company when selected by the distinguished member.

That is, the referral module 230 may facilitate one member (e.g., the distinguished member) of a social network to refer a friend, associate, or other connection with the social network to a job or company advertising a job, by providing the member with recommendations (via messages, widgets, and so on) about what connections would be candidates for jobs advertised by the member's company.

In some examples, the analysis module 240 is configured and/or programmed to analyse referral information, such as information associated with a number of referrals performed by members, a number of referrals accepted, and so on. The analysis module 240 may generate reports for members, such as reports for members that utilize the social network 130 to recruit for job candidates or otherwise facilitate the connection of members to available jobs. The social network 130 may utilize such data when presenting various statistics or other information to these members, among other things.

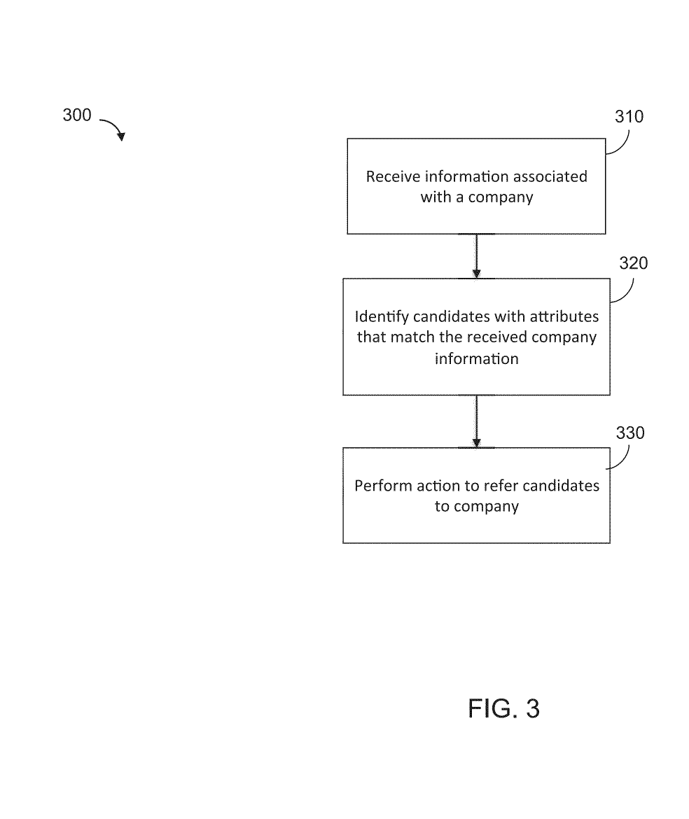

As described herein, the referral system 140 may utilize information associated with jobs and information associated with members of the social network 130 to facilitate referrals of members as job candidates, among other things. FIG. 3 is a flow diagram illustrating an example method 300 for referring members of a social network as job candidates, consistent with some embodiments.

In step 310, the referral system receives and/or obtains information associated with a company. For example, the jobs module 210 of the referral system 140 receives and/or obtains information from a jobs database 134 of the social network 130. In some examples, the received information may include information describing a company, such as biographical information for the company, historical information for the company, information associated with members of the social network that are affiliated with the company, and so on. In some examples, the received information may include information associated with an available job at the company, such as a job title, a job description, work experience or educational requirements, location information, and so on.

In step 320, the referral system identifies members of the social network having attributes that match the received company and/or job information. For example, the candidate module 220 of the referral system 140 reviews data stored in the member database 132 of the social network 130 to identify members associated with information (e.g., attributes) that match the received job information.

In some examples, matching job information to member attributes may include matching of one or more attributes associated with a member to a job title, job description, or other information associated with an available job. For example, a member attribute of a previous job title of “product manager” may match a job description of “product manager” or “product lead,” but not a job description of “product designer.” As another example, a member attribute of “HTML experience” may match a job title of “front end web developer,” but a member attribute of “front of house dining” may not match the same job title.

Thus, in some examples, the referral system may perform one or multiple different match algorithms between a member and information associates with a company or job when determining whether a member matches a job. Furthermore, as described herein, the referral system may determine and assign a match score to a member that indicates a level of matching between a member and an available job.

In step 330, the referral system refers an identified member of the social network as a job candidate. For example, the referral module 230 of the referral system 140 performs an action associated with referring an identified member as a candidate for the available job. For example, the referral system may generate and transmit an email to a distinguished member of the social network that is affiliated with the company advertising the job and connected to the members of the social network identified as candidates for the job. The email, or other message, may present information associated with identified members, along with user-selectable objects configured to cause the social network to refer the one or more members to the company when selected by the distinguished member.

As another example, the referral system may generate and display a widget via the distinguished member's home page of the social network that presents information about the identified members along with user-selectable objects configured to cause the social network to refer the one or more members to the company when selected by the distinguished member.

Thus, the referral system may facilitate one member (e.g., the distinguished member) of a social network to refer a friend, associate, or other connection with the social network to a job or company advertising a job, by providing the member with recommendations (via messages, widgets, and so on) about what connections would be candidates for jobs advertised by the member's company, among other things.

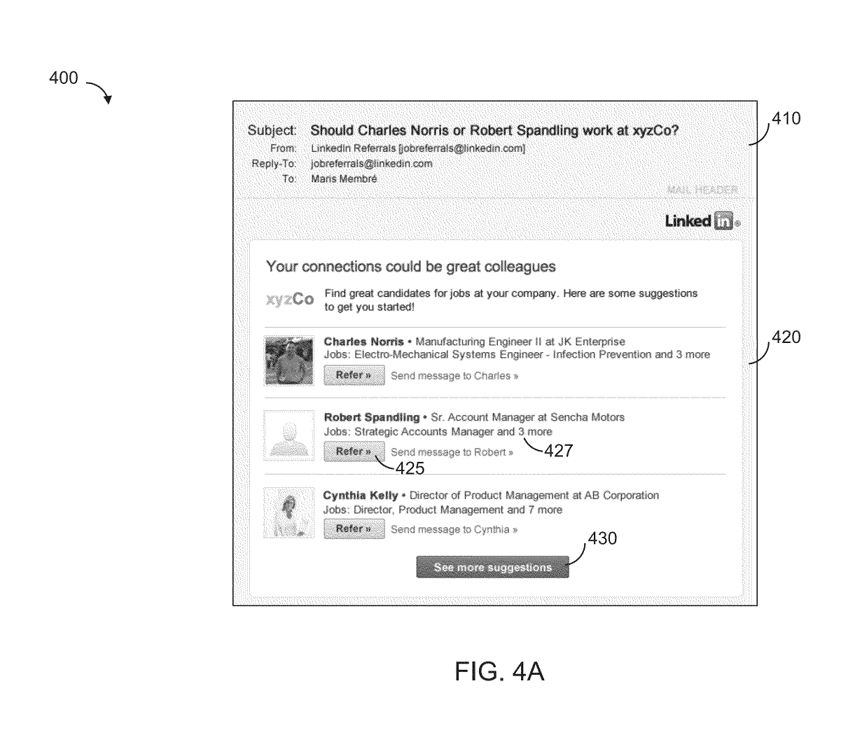

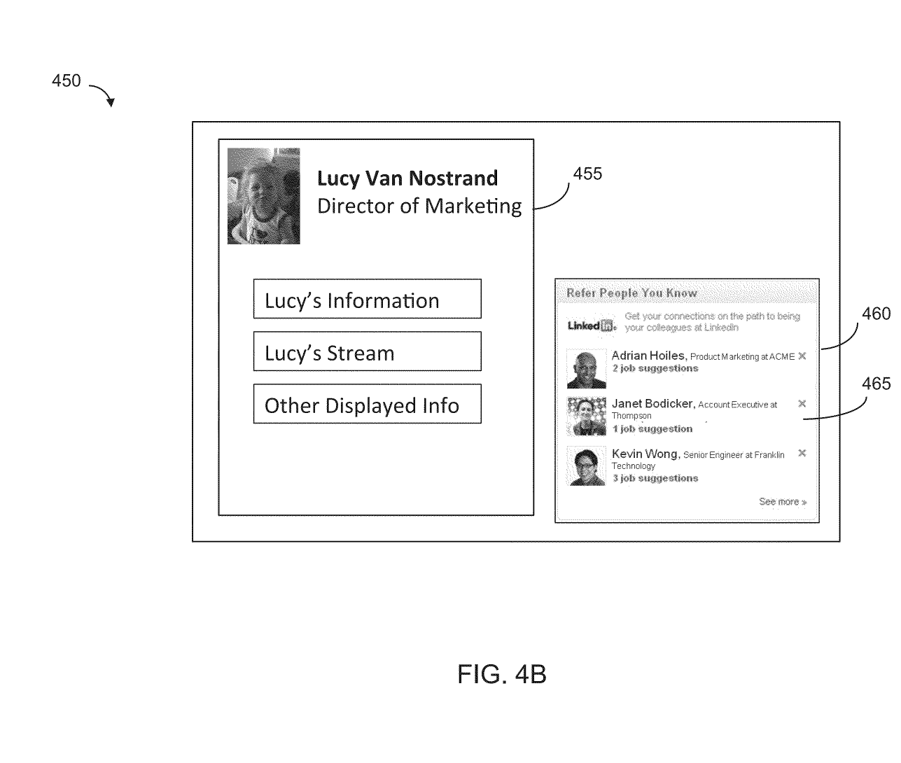

The following user interface displays illustrate the actions performed by the referral system, in some example embodiments. FIGS. 4A-4B are display diagrams illustrating actions performed to refer members of a social network as job candidates, consistent with some embodiments.

FIG. 4A depicts a screen shot of an email 400 sent by the referral system 140 to a distinguished member of the social network 130. The email 400 displays header information 410 and a listing 420 of members of the social network 130 identified as referral candidates. Each listing displays the name of the member, the current title associated with the member, a link 427 to and description of possible jobs in which to refer the member, and a user-selectable button 425 that, when selected by the distinguished member, causes the referral system to initiate a referral process for the listed member. The email 400 may also include other user-selectable buttons, such as a button 430 that, when selected by the distinguished member, causes the referral system to display additional members identified as referral candidates.

In some examples, the referral system may display identified members according to match scores, or other metrics, that rank or order the members. For example, the referral system 140 may identify the top three members connected to a distinguished member that have the highest match scores to various jobs advertised by the company at which the distinguished member is currently employed. Of course, the referral system 140 may rank, sort, order, or otherwise display members using a variety of different rules or selection criteria.

In addition to an email or other messages, the referral system may integrate the display of referral candidates within various pages of the social network 130. FIG. 4B depicts a screen shot 450 of a member home page that includes member information 455 and a widget 460 that displays various members 465 connected to the member that have been identified as referral candidates.

When a user-selectable button, such as the button 425 of FIG. 4A, is selected, the referral system 140 may perform a variety of different actions in order to initiate a referral for a member to a job and/or company. For example, the referral system 140 may initiate a communication (e.g., an email or internal message) between a member receiving the email 400 and the member identified as a potential candidate. As another example, the referral system 140 may initiate a communication between the member identified as a potential candidate and another member of the social network associated with an available job, such as a recruiter that posted the job on behalf of the company.

Thus, in some examples, the referral system utilizes information stored and/or created by a social network, such as a professional network, to identify members of the social network to be referred to a company or job as potential candidates, among other things. The referral system 140, therefore, may facilitate connections between members looking for jobs and members looking for job candidates, even though the members themselves are not connected, among other things.

### Presenting Referred Candidates to Recruiters

As described herein, in some examples, the system may analyse the referral data within the system and generate reports for members, such as reports for members that utilize the social network service 130 to recruit for job candidates or otherwise facilitate the connection of members to available jobs. The social network service 130 may utilize such data when presenting information associated with referral candidates to such members, such as ranked referral candidates or other information.

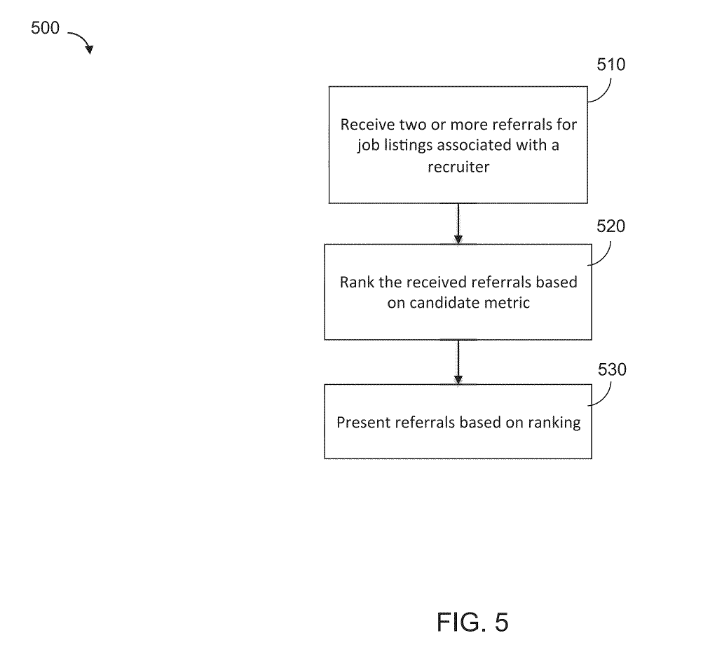

FIG. 5 is a flow diagram illustrating an example method 500 for presenting referral candidate information, consistent with some embodiments. In step 510, the system receives two or more referrals for job listings associated with a recruiter. For example, the analysis module 240 of FIG. 2 receives information identifying multiple referrals performed by the referral module 230 of the referral system 140. The received information may include information identifying a member of the social network that has been referred by another member, information identifying the job and/or company to which the member was referred, a match score or other metric that indicates a level of interest associated with the member as a candidate for the listed job, and so on.

In step 520, the system ranks the received referrals based on assigned metrics, such as match scores. For example, the analysis module 240 may rank or otherwise order received referrals based on the scores assigned to the referrals. Such rankings may be generic for all recruiters and/or tailored for a specific recruiter. For example, one recruiter may consider certain factors that contribute to a match score to be more relevant, while another recruiter may consider other factors to be relevant.

In step 530, the system presents the referrals to the recruiter based on the ranking For example, the analysis module 240 may present and/or display referrals in order of highest score to lowest score to a recruiter via a user interface associated with a recruiter, such as via one or pages within the social network that are associated with the recruiter and/or a company affiliated with the recruiter.

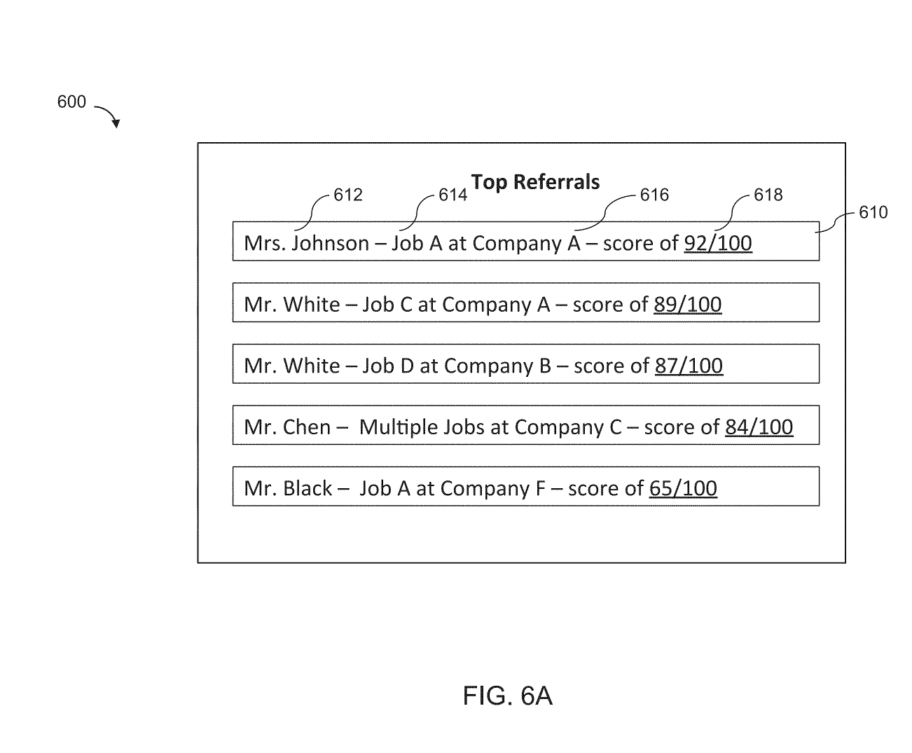

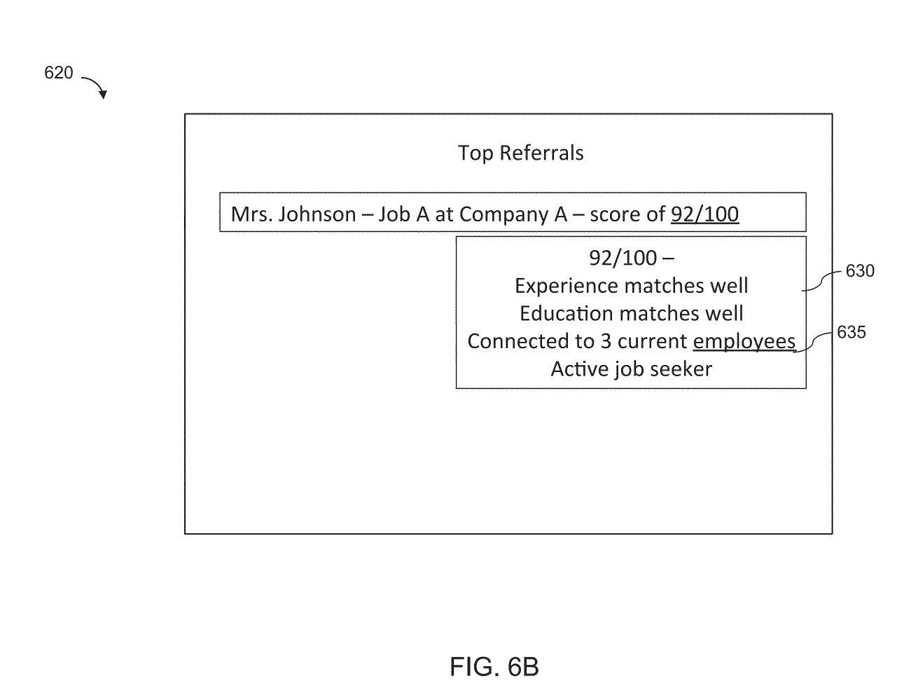

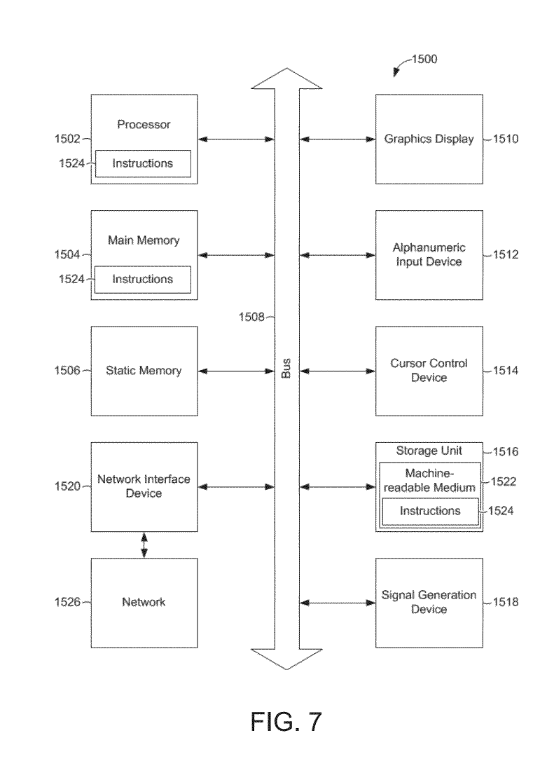

FIGS. 6A-6B are display diagrams illustrating the presentation of referral candidate information via a user interface, consistent with some embodiments. FIG. 6A depicts a page 600 displayed by a social network that provides information associated with referrals to a recruiter or other member within the social network. The page 600 lists the “top referrals” for the recruiter, such as referral 610. Referral 610 displays, for example, information 612 identifying the member being referred, information 614 identifying the job and information 616 identifying the sponsoring company to which the member was referred, and information 618 identifying a match score or other information that scores or otherwise assigns a calculated weight to the referral 610. Of course, other information may be displayed within the page 600, such as information identifying a referring member, member profile information, social graph connections for the member, and so on.

In some examples, the displayed referral 610 may include links that, when selected, cause the system to display additional information, such as the link provided within the information 618 identifying the match score. FIG. 6B depicts a page 620 that is displayed upon a member selecting the linked information 618 displayed by page 600.

Page 620 provides a newly displayed window 630 that provides details 635 associated with the match score for the referral 610. For example, the window 630 displays some of the information utilized by the system when calculating the match score. When a recruiter is reviewing displayed referrals, the system enables the recruiter to identify and request additional information for a member, a job listing, referral ranking methodologies, social graph connections, and so on.

Thus, in some examples, the referral system 140 described herein provides a recruiter within a social network with a ranked list of possible referral candidates for jobs the recruiter is actively or passively seeking candidates. By ranking the referrals, the referral system 140 identifies the members of the social network that are desirable job candidates, enabling the recruiter to target these members and enabling the members to receive inquiries of interest from recruiters, among other benefits.

### CONCLUSION

Thus, in some example embodiments, the referral system 140 enables a social network to facilitate referrals of members of the social network as candidates for jobs, among other benefits.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

FIG. 5 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method, comprising:
receiving information associated with a company;
identifying one or more members of a social network having attributes that match the received information associated with the company; and
performing an action with respect to a distinguished member of the social network that is associated with the company and that is associated with the identified one or more members.

2. The method of claim 1, wherein performing an action with respect to a distinguished member of the social network includes generating and transmitting an email to the distinguished member that presents information associated with the identified one or more members along with user-selectable objects configured to cause the social network to refer the one or more members to the company.

3. The method of claim 1, wherein performing an action with respect to a distinguished member of the social network includes generating and displaying a widget on a profile page of the distinguished member that presents information associated with the identified one or more members along with user-selectable objects configured to cause the social network to refer the one or more members to the company.

4. The method of claim 1, wherein receiving information associated with a company includes receiving information associated with a job advertisement for a vacant position at the company; and
wherein identifying one or more members of the social network includes identifying one or more members that have been assigned an attribute that matches the information associated with the job advertisement.

5. The method of claim 1, wherein receiving information associated with a company includes receiving a job description for a vacant position at the company; and
wherein identifying one or more members of the social network includes identifying one or more members having an attribute that matches the job description.

6. The method of claim 1, wherein receiving information associated with a company includes receiving a job description for a vacant position at the company; and;
wherein identifying one or more members of a social network includes identifying one or more members having work experience attributes that match the job description.

7. The method of claim 1, wherein receiving information associated with a company includes receiving a job description for a vacant position at the company; and;
wherein identifying one or more members of a social network includes identifying one or more members having education attributes that match the job description.

8. The method of claim 1, wherein receiving information associated with a company includes receiving a job description for a vacant position at the company; and;
wherein identifying one or more members of a social network includes identifying one or more members having skills attributes that match the job description.

9. The method of claim 1, wherein identifying one or more members of a social network having attributes that match the received information associated with the company includes identifying one or more members that are active candidates for job openings.

10. The method of claim 1, wherein identifying one or more members of a social network having attributes that match the received information associated with the company includes identifying one or more members that are passive candidates for job openings.

11. A system for referring members of a social network to a company seeking job candidates, the system comprising:
at least one processor-implemented hardware module, including:
a jobs module, wherein the jobs module is configured to receive information associated with an available job at a company;
a candidate module, wherein the candidate module is configured to identify one or more members of the social network as candidates for the available job; and
a referral module, wherein the referral module is configured to perform an action associated with referring at least one of the identified one or more members as a candidate for the available job.

12. The system of claim 11, wherein the candidate module is configured to identify a member of the social network as a candidate for the available job when the candidate module matches at least one attribute assigned to the candidate with information associated with the available job.

13. The system of claim 11, wherein the candidate module is configured to identify a member of the social network as a candidate for the available job when the candidate module matches at least one work experience attribute assigned to the candidate with a job description of the available job.

14. The system of claim 11, wherein the referral module is configured to generate and send an email to a member of the social network that is connected to the identified one or more members and associated with the company, the generated email including information identifying the one or more members and user-selectable buttons that, when selected, facilitate a referral of a member to the company as a candidate for the available job.

15. The system of claim 11, wherein the jobs module receives information associated with the available job at the company from a jobs database contained by the social network; and wherein the candidate module identifies the one or more members of the social network as candidates for the available job based on member information obtained from a member database contained by the social network.

16. The system of claim 11, wherein the jobs module receives information associated with the available job at the company from a job listing website in communication with the social network; and wherein the candidate module identifies the one or more members of the social network as candidates for the available job based on member information obtained from a member database contained by the social network.

17. A computer-readable storage medium whose contents, when executed by a processor of a computing system, cause the computing system to perform a method, comprising:
receiving information associated with a company;
identifying one or more members of a social network having attributes that match the received information associated with the company; and
performing an action with respect to a distinguished member of the social network that is associated with the company and that is associated with the identified one or more members.

18. The computer-readable storage medium of claim 17, wherein performing an action with respect to a distinguished member of the social network includes generating and transmitting an email to the distinguished member that presents information associated with the identified one or more members along with user-selectable objects configured to cause the social network to refer the one or more members to the company.

19. The computer-readable storage medium of claim 17, wherein performing an action with respect to a distinguished member of the social network includes generating and displaying a widget on a profile page of the distinguished member that presents information associated with the identified one or more members along with user-selectable objects configured to cause the social network to refer the one or more members to the company.

20. The computer-readable storage medium of claim 17, wherein receiving information associated with a company includes receiving information associated with a job advertisement for a vacant position at the company; and
wherein identifying one or more members of the social network includes identifying one or more members that have been assigned an attribute that matches the information associated with the job advertisement.
